(19) United States
(12) Patent Application Publication
(10) Pub. No.: US 2007/0215247 A1
(43) Pub. Date: Sep. 20, 2007

(54) GRAPPLE SAW

(76) Inventor: Calvin S. Johnson, Union Grove, NC (US)

Correspondence Address: ADAMS EVANS P.A., Suite 2350 Charlotte Plaza, 201 South College Street, CHARLOTTE, NC, 28244, US

(21) Appl. No.: 11/276,883

(22) Filed: Mar. 17, 2006

(51) Int. Cl. A01G 23/08

(52) U.S. Cl. 144/336; 144/4.1; 144/34.1

(57) ABSTRACT

A grapple saw includes grapple having downwardly-extending jaws for holding a log therebetween, the jaws moveable between an open position and a closed position in a gripping direction; and a saw carried by the grapple, the saw having a blade moveable between starting and ending positions in a cutting plane generally parallel to the gripping direction, so as to sever a log held in the jaws. The ending position of the saw blade is substantially horizontal, so as to prevent twisting of a free end of the severed log relative to the grapple.

### BACKGROUND OF THE INVENTION

This invention relates to logging equipment and more particularly to grapples used to lift and move trees and logs.

In the logging industry, it is a well-known procedure to top, delimb, rough-cut, and otherwise partially process trees very close to the location where they are felled. This saves the cost of transporting entire trees, reduces the amount of waste material generated at the sawmill or processing plant, and also makes transportation easier because the trees are in a more-or-less uniform cylindrical shape and size after topping and delimbing.

One common type of machinery used in field processing of trees is a “grapple saw”. A grapple is a mechanism with moveable jaws used to grip and move felled trees. Grapples are typically carried by moveable booms mounted on skidder vehicles or independent loaders. Some of these grapples have saws mounted thereto which can be used to cut the trees down to shorter lengths. While these grapple saws are effective, they typically complete the cut in a way that causes the log to twist on completion of the cut. This can pinch the saw and possibly damage or break the saw, and also presents a risk to personnel nearby as the log rolls away.

Accordingly, it is an object of the invention to provide a grapple saw which avoids twisting of a log as it is cut.

It is another object of the invention to provide a grapple saw which has minimal ground contact during a cutting operation.

### BRIEF SUMMARY OF THE INVENTION

These and other objects are met by the present invention, which in one aspect provides a grapple saw, including: a grapple having downwardly-extending jaws for holding a log therebetween, the jaws moveable between an open position and a closed position in a gripping direction; a saw carried by the grapple, the saw having a blade moveable between starting and ending positions in a cutting plane generally parallel to the gripping direction, so as to sever a log held in the jaws, wherein the ending position of the saw blade is substantially horizontal, so as to prevent twisting of a free end of the severed log relative to the grapple.

According to another aspect of the invention, the jaws are moveable about at least one pivot axis, and the saw is moveable about a pivot point disposed substantially below both the at least one pivot axis.

According to another aspect of the invention, the saw includes a chain carried on a moveable bar.

According to another aspect of the invention, the saw is enclosed in a saw box mounted to the grapple.

According to another aspect of the invention, a grapple saw includes: a grapple having at least one pair of downwardly-extending jaws for holding a log therebetween, the jaws pivotable about a common axis to move in a gripping direction between an open position and a closed position; and a saw carried by the grapple, the saw having a blade moveable about a pivot point in a cutting plane generally parallel to the gripping direction between starting and ending positions so as to sever a log held in the jaws, wherein the pivot point is disposed substantially below the common axis of the jaws.

According to another aspect of the invention, a grapple saw includes: a grapple having a frame and at least one pair of downwardly-extending jaws for holding a log therebetween, the jaws pivotable about spaced-apart jaw pivots to move in a gripping direction between an open position and a closed position; a saw box mounted to the frame and having a first end having a pivot axis and a second ends having a pivot point, the saw box moveable about the pivot axis between a stowed position and a cutting position in which the pivot point is disposed substantially below the jaw pivots; a saw carried by the saw box and pivotable about the pivot point between starting and ending positions in a cutting plane generally parallel to the gripping direction, so as to sever a log held in the jaws.

According to another aspect of the invention, the ending position of the saw is substantially horizontal, so as to prevent twisting of a free end of the severed log relative to the grapple.

According to another aspect of the invention, the frame carries a convex saddle adapted to stabilize a log gripped in the jaws.

According to another aspect of the invention, the saw box includes a concave edge adapted to bear against a log in the cutting position.

According to another aspect of the invention, a method of cutting a log includes: providing a grapple having jaws for holding a log therebetween, the Jaws moveable between an open position and a closed position in a gripping direction; providing a saw carried by the grapple, the saw having a blade moveable in a cutting path within a plane generally parallel to the gripping direction; gripping the log in the jaws of the grapple; moving the saw blade along the cutting path to engage and progressively sever the log; and directing a terminal portion of the saw movement such that, upon completion of cutting, a free end of the log separates from the remainder of the log substantially free from any twisting motion about a long axis of the log.

According to another aspect of the invention, the saw blade terminates the cut in a substantially horizontal position.

### BRIEF DESCRIPTION OF THE DRAWINGS

The invention may be best understood by reference to the following description taken in conjunction with the accompanying drawing figures in which:

FIG. 1 is a side view of a grapple saw constructed in accordance with the present invention;

FIGS. 2A-2C are front views showing the grapple saw of FIG. 1 during a cutting sequence on a first log;

FIGS. 3A-3C are front views showing the grapple saw of FIG. 1 during a cutting sequence on a second log;

FIGS. 4A-4C are front views showing the grapple saw of FIG. 1 during a cutting sequence on a third log;

FIGS. 5A-5C are front views showing an alternative grapple saw during a cutting sequence on a fourth log;

FIGS. 6A-6C are front views showing the grapple saw of FIG. 5 during a cutting sequence on a fifth log; and

FIGS. 7A-7C are front views showing the grapple saw of FIG. 5 during a cutting sequence on a sixth log.

### DETAILED DESCRIPTION OF THE INVENTION

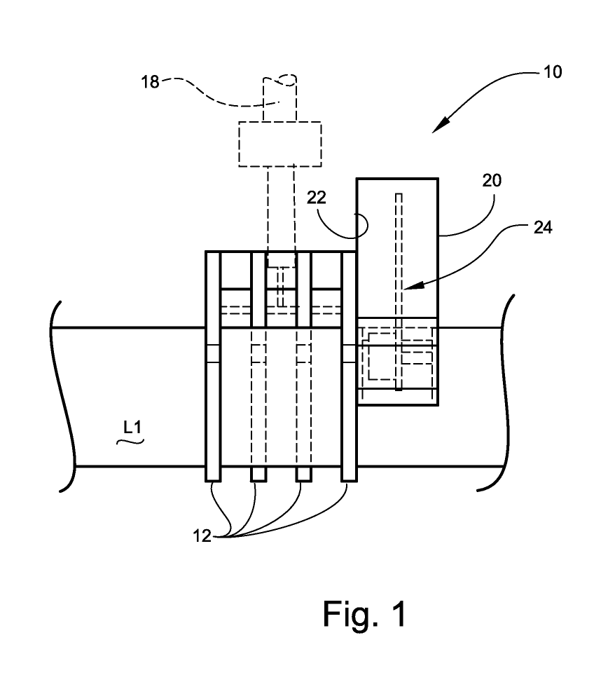

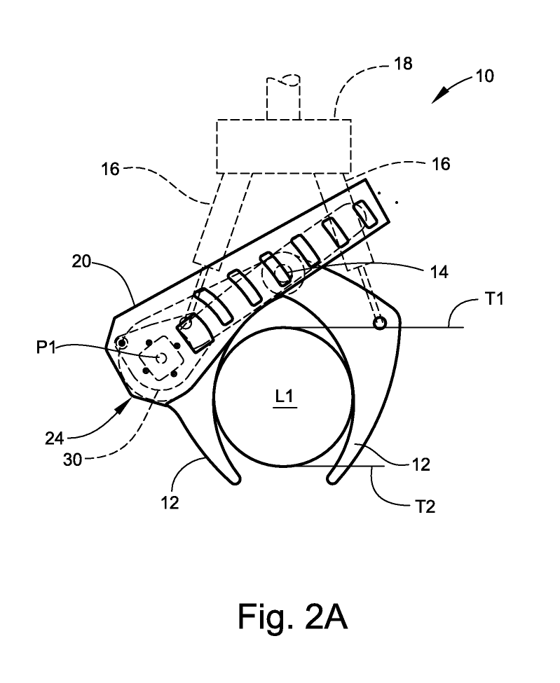

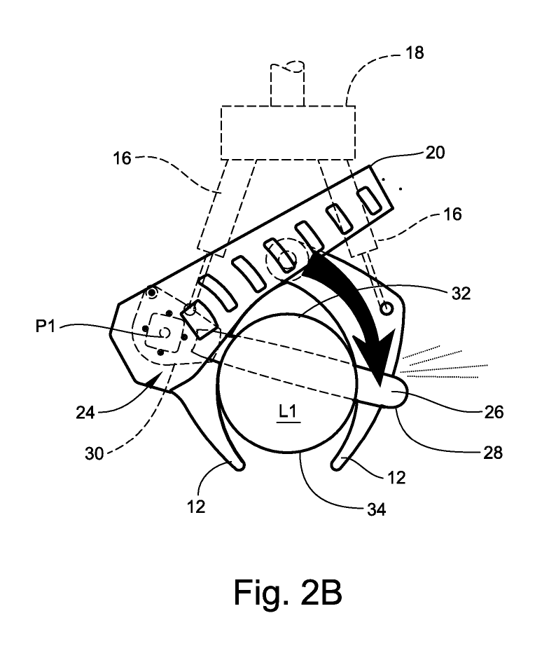

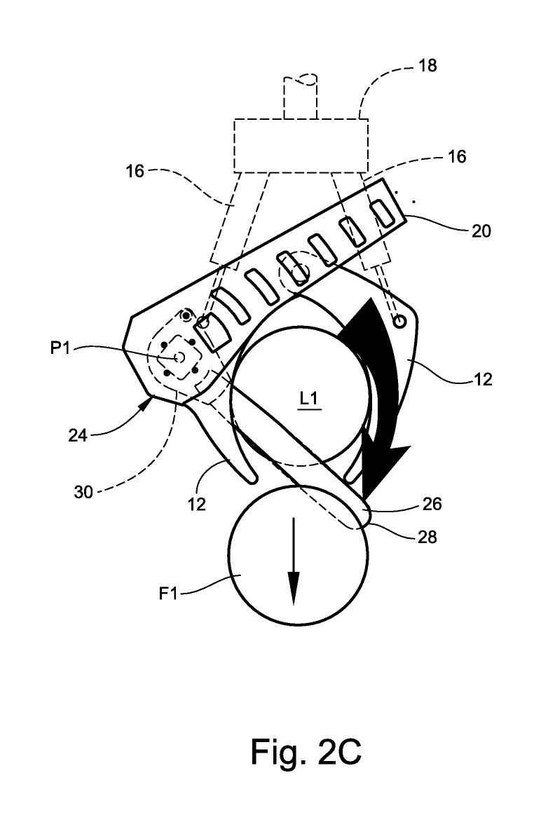

Referring to the drawings wherein identical reference numerals denote the same elements throughout the various views, FIGS. 1 and 2 illustrate an exemplary grapple 10. The grapple 10 includes one or more pairs of opposed jaws 12 which are pivoted open and closed about a common axis 14 by hydraulic cylinders 16, which are in turn mounted to the end of a moveable boom 18 of a known type. The motion of the jaws 12 define a gripping direction which is generally perpendicular to the log or object to be gripped. A saw box 20 having an opening 22 is mounted to one of the outermost jaws 16. The saw box 20 encloses a saw 24 which is moveable between a retracted position, shown in FIG. 2A, and an extended position, shown in FIG. 2C.

In the illustrated example, the saw 24 is a chainsaw having a bar 26 and a chain 28 driven by a hydraulic motor 30, or other suitable power source. Means such as a hydraulic cylinder (not shown) or other suitable actuator are provided to pivot the bar 26 about a pivot point “P1”.

In contrast to prior art practice, the pivot point P1 is carefully located to achieve a specific cutting motion. This cutting motion is shown in FIGS. 2A-2C on a relatively large log “L1”. As used herein, the term “log” is used to refer generally to the workpiece, whether it is an entire tree trunk or a shorter portion already cut therefrom. The process begins by clamping the log L1 in the jaws 12, with the saw 24 in the retracted position (FIG. 2A). The grapple 10 is primarily used to stabilize the log L1 during the cut, and 50 it is typically not lifted above the ground. The saw 24 is then started and moved downward to engage and cut the log L1. The bar 26 pivots about point P1 which is positioned relatively low on the jaw 16. The bar 26 moves within a plane generally parallel to the gripping direction (in other words, it does not intersect a line defining the gripping direction). FIG. 2B shows the cut partially completed.

FIG. 2C shows the cut at the instant of completion, with a free end “F1” of the log L1 falling away. As the cut progresses, less and less of the log cross-section remains intact at the cutting plane. At some point, the remaining material will be insufficient to keep the log L1 intact and the free end F1 will begin to fall away from the remainder of the log L1 even though it is not completely severed. In a prior art grapple saw (not shown), with a saw pivoted at a high point on the grapple, the cut is completed with the saw bar close to a vertical position. This causes the log to twist apart about its long axis, which can pinch and possibly damage the saw bar and cause a safety hazard to nearby personnel. The prior art saw bar also extends substantially below the jaws which can cause it to contact the ground during a cut. This is highly abrasive and causes rapid wear of the saw.

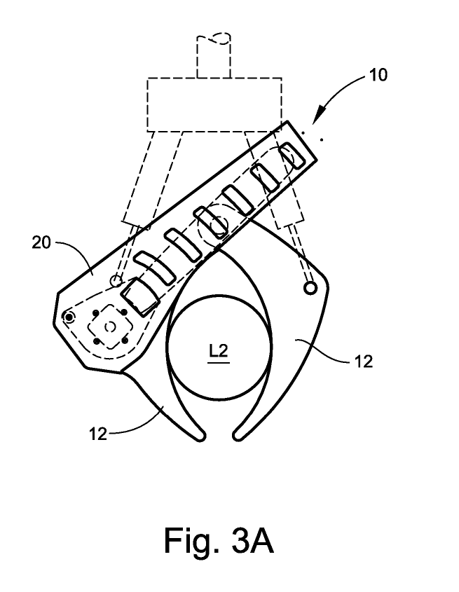

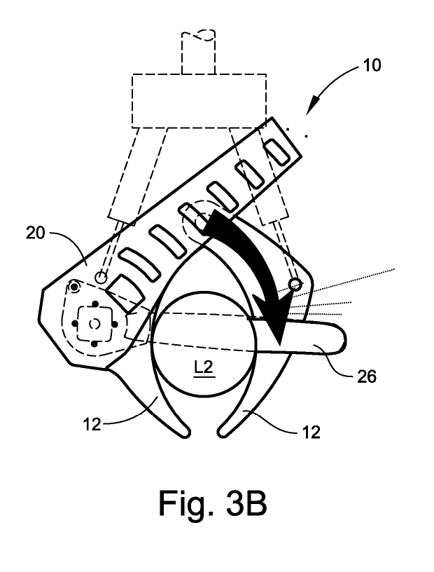

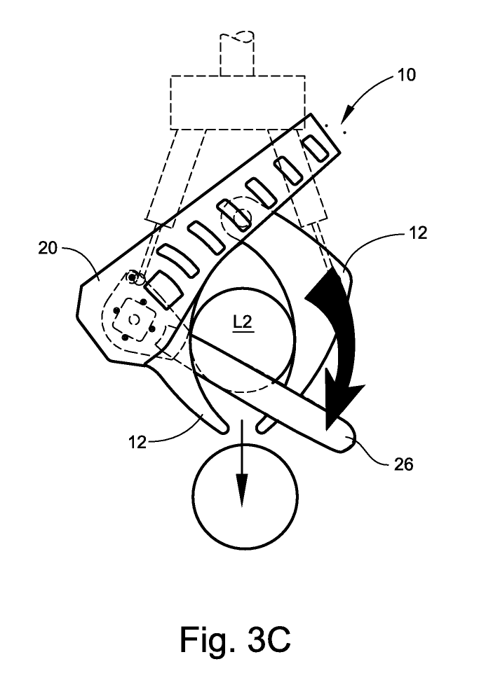

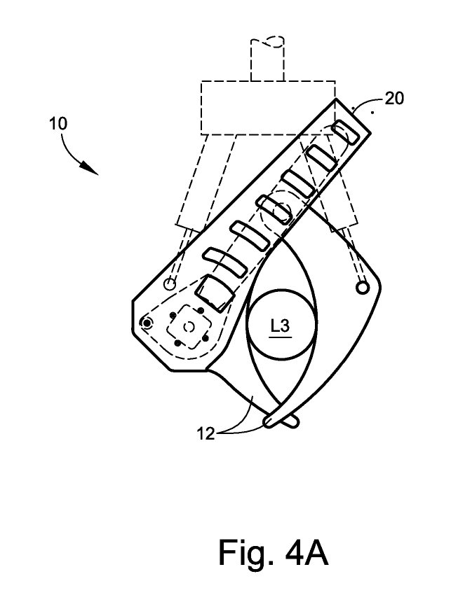

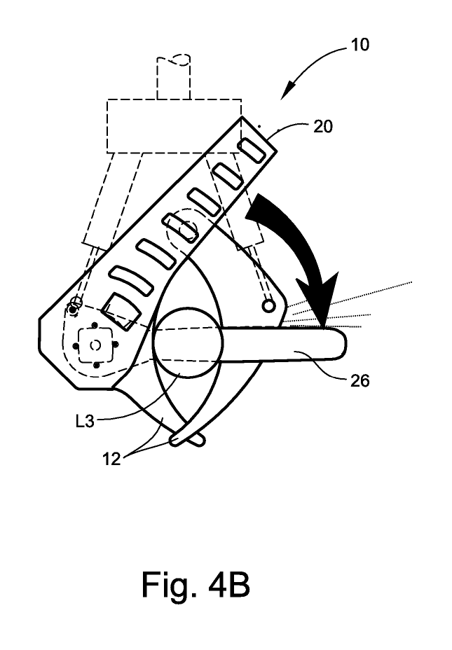

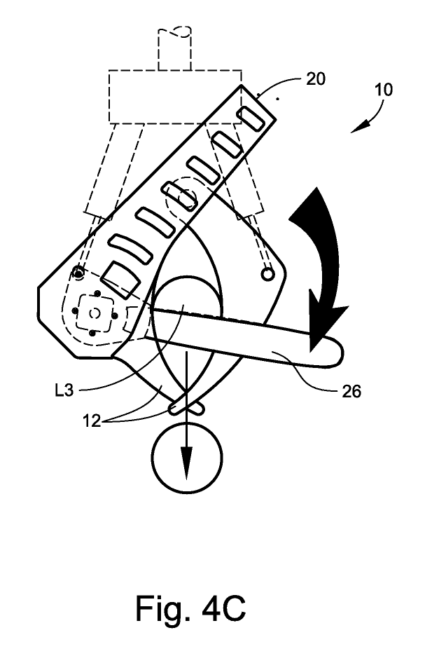

The low pivot point P1 of the saw 24 causes it to closely approximate a horizontal position at the end of the cut. The twisting tendency of the log L1, if any, is greatly reduced. The exact nature of the cut will vary depending upon the size of the log which is cut. Ideally, the saw 24 will be as close to horizontal as possible upon completion. FIGS. 3A-3C show the steps in cutting a log L2 which is smaller than the log L1, and FIGS. 4A-4C show the steps in cutting another log L3 which is yet smaller than the log L2. In the particular example shown, the saw bar 26 is most nearly horizontal at the cut termination with the smallest log L3. In each case, the protrusion of the saw bar 26 below the jaws 16 is limited such that minimal ground contact is experienced.

The size and shape of the grapple jaws 16 as well as the location of the pivot point P1 may be chosen so that the greatest reduction of twist is achieved with a log of a specific size. In general, the pivot point P1 is located substantially below the jaw pivot axis 14. More specifically, the pivot point P1 may be positioned below a line “T1” tangent to a top surface 32 of the log L1. The greatest reduction in twist will be achieved when the pivot point P1 is at approximately at the level of a line “T2” tangent to a bottom surface 34 of the log L1.

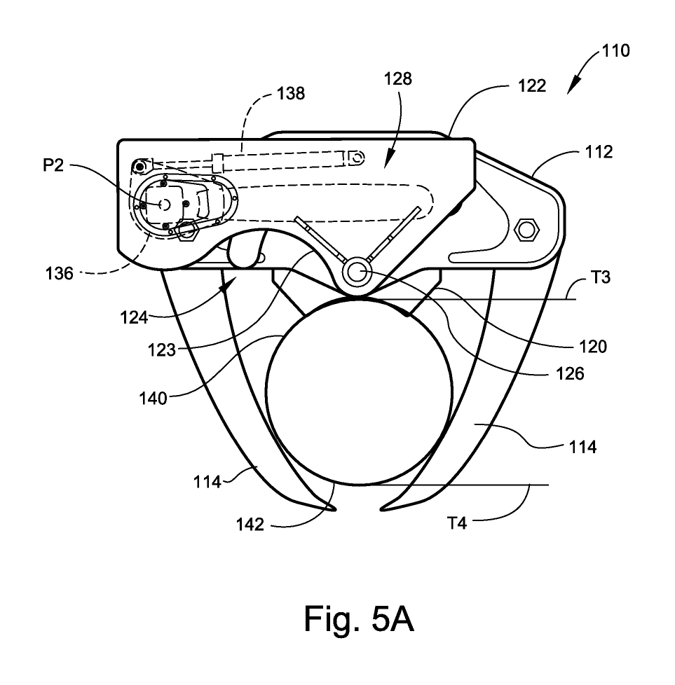

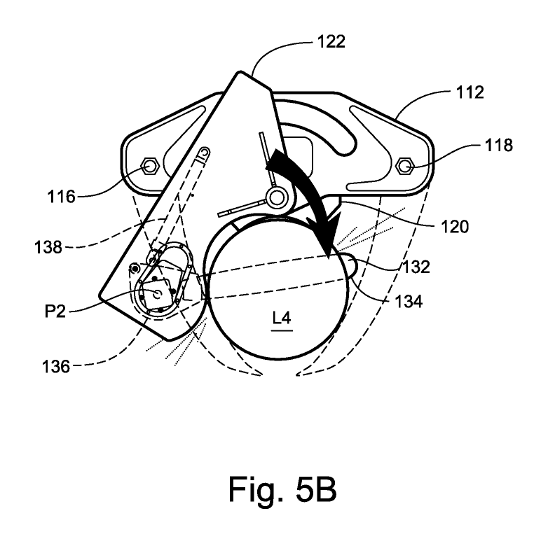

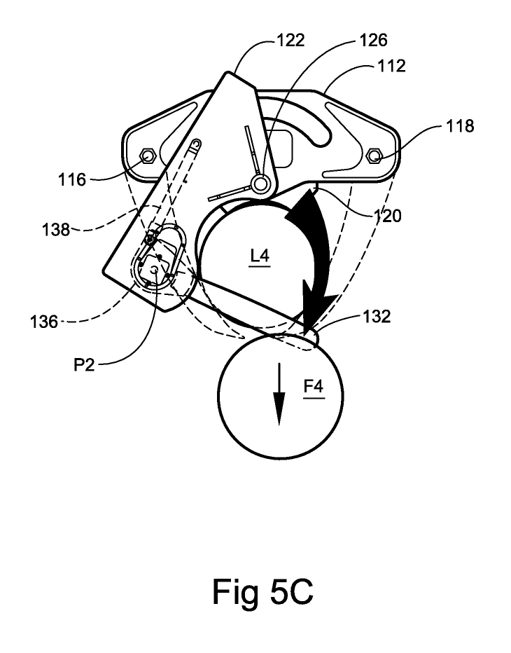

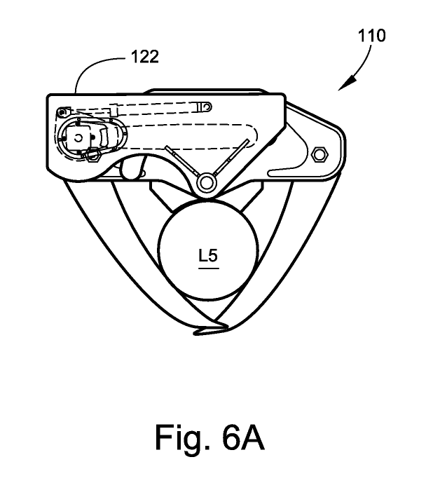

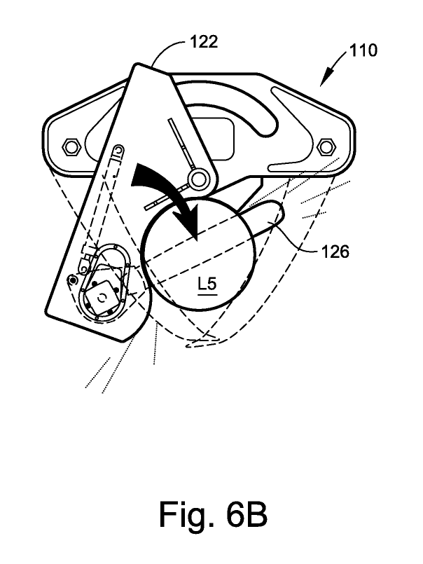

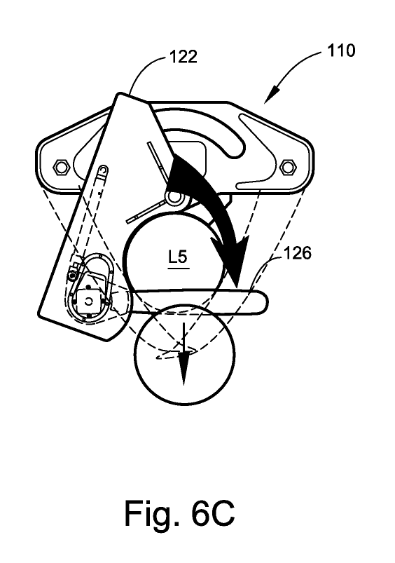

FIG. 5A illustrates another exemplary grapple 110 which is intended to be carried by a log skidder of a known type. The grapple 110 includes a frame 112 and one or more pairs of opposed jaws 114 which are pivoted open and closed about spaced-apart pivot axes 116 and 118. The motion of the jaws 114 define a gripping direction which is generally perpendicular to the log being gripped. A concave saddle 120 is provided to bear against and stabilize a log during the cut.

A saw box 122 having an opening 124 is mounted to a the frame 112. The saw box pivots about an axis 126 between a stowed position, shown in FIG. 5A, and a cutting position, shown in FIG. 5B. The saw box 122 encloses a saw 128 which is moveable between a retracted position, shown in FIG. 5B, and an extended position, shown in FIG. 5C. The saw box 122 has a concave edge 123 adapted to bear against a log and stabilize it during a cut. In the illustrated example, the saw 128 is a chainsaw having a bar 132 and a chain 134 driven by a hydraulic motor 136, or other suitable power source. Means such as the illustrated hydraulic cylinder 138 are provided to pivot the bar 132 about a pivot point “P2”.

The pivot point P2 is carefully located to achieve a specific cutting motion. This cutting motion is shown in FIGS. 5B and 5C on a relatively large log “L4”. The process begins by clamping the log L4 in the jaws 114 and against the saddle 120 with the saw box 122 in the stowed position and the saw 128 in a retracted position (FIG. 5A). The grapple 110 is primarily used to stabilize the log L4 during the cut, and so it is typically not lifted above the ground. The sawbox 122 is lowered until it contacts the log L4, and the saw 128 is then started and moved downward to engage and cut the log L4. The bar 132 pivots about point P2 which is positioned a substantial amount below the frame 112. The motion of the bar 132 lies within a plane that is generally perpendicular to the gripping direction (in other words, the plane does not intersect the cutting direction). FIG. 5B shows the cut partially completed.

FIG. 5C shows the cut at the instant of completion, with a free end “F4” of the log L4 falling away. As the cut progresses, less and less of the log cross-section remains intact at the cutting plane. At some point, the remaining material will be insufficient to keep the log L4 intact and the free end F4 will begin to fall away from the remainder of the log L4 even though it is not completely severed.

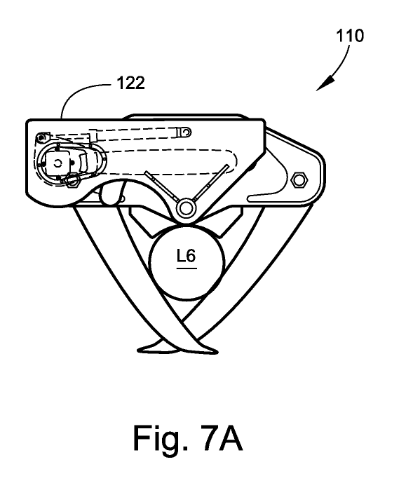

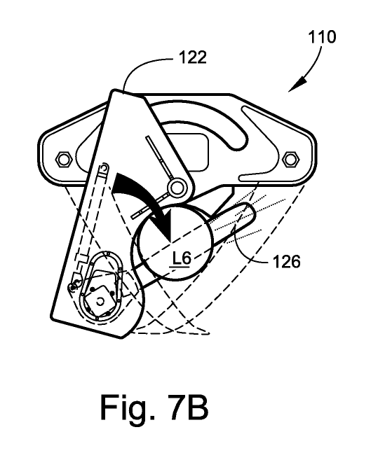

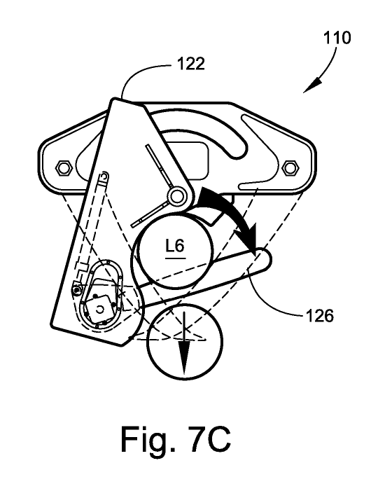

The low pivot point P2 of the saw 128 causes it to closely approximate a horizontal position at the end of the cut. The twisting tendency of the log L4, if any, is greatly reduced. The exact nature of the cut will vary depending upon the size of the log which is cut. Ideally, the saw 128 will be as close to horizontal as possible upon completion. FIGS. 7A-7C show the steps in cutting a log L5 which is smaller than the log L4, and FIGS. 8A-8C show the steps in cutting another log L6 which is yet smaller than the log L5. In the particular example shown, the saw bar 132 is most nearly horizontal at the cut termination with the intermediate size log LS. In each case, the protrusion below the saw box 122 is limited such that minimal ground contact is experienced.

The size and shape of the saw box 122 as well as the location of the pivot point P2 may be chosen so that the greatest reduction of twist is achieved with a log of a specific size. In general, the pivot point P2 is located substantially below the saw box pivot axis 126. More specifically, the pivot point P2 may be positioned below a line “T3” tangent to a top surface 140 of the log L4. The greatest reduction in twist will be achieved when the pivot point P2 is approximately at the level of a line “T4” tangent to a bottom surface 142 of the log L4.

The foregoing has described a grapple saw. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

1-14. (canceled)

15. A grapple saw for cutting a log from a felled tree, comprising:
(a) a grapple for being suspended above the ground from a boom and having opposing jaws extending downwardly towards the felled tree from a common pivot axis to grasp and hold the felled tree therebetween, the jaws pivotable from an open to a closed position in directions generally perpendicular to the felled tree; and
(b) a saw mounted on one of the jaws below the common pivot axis to pivot generally perpendicularly to the felled tree for making a cut vertically through the felled tree to form a log and to reduce twisting of a free end of the log during cutting.

16. The grapple saw of claim 15 wherein the saw includes a chain carried on a movable bar.

17. The grapple saw of claim 15 wherein the saw is enclosed in a saw box mounted to the grapple.

18. A grapple saw for cutting a log from a felled tree, comprising:
(a) a grapple having at least one pair of downwardly extending jaws for holding a felled tree in generally parallel relation to the ground, the jaws pivotable about a common axis to move from an open position to a closed position in directions generally perpendicular to the ground;
(b) a saw carried by the grapple, the saw having a blade movable about a pivot point between starting and ending positions and in a cutting plane generally perpendicular to the ground, the pivot point disposed below the common axis of the jaws to reduce twisting of a free end of the log during cutting.

19. The grapple saw of claim 18 wherein the saw includes a chain carried on a moveable bar.

20. The grapple saw of claim 18 wherein the saw is enclosed in a saw box mounted to the grapple.

21. A grapple saw for cutting logs from a felled tree comprising:
(a) a grapple suspended above the ground and having a frame and at least one pair of jaws extending downwardly toward the ground for holding a generally horizontally disposed log there between, the jaws pivotable perpendicularly with respect to the ground about spaced-apart jaw pivots from open to closed positions;
(b) a saw box mounted to the frame and having a first end including a pivot axis and a second end including a pivot point disposed below the jaw pivots, the saw box movable about the pivot axis between a stowed position and a cutting position; and
(c) a saw carried by the saw box and pivotable about the pivot point between starting and ending positions in a cutting plane generally perpendicular to the generally horizontally disposed log.

22. The grapple saw of claim 21 wherein the saw includes a chain carried on a moveable bar.

23. The grapple saw of claim 21 wherein the saw is enclosed in a saw box mounted to the grapple.

24. The grapple saw of claim 21 wherein the ending position of the saw is substantially horizontal.

25. The grapple saw of claim 8 wherein the frame carries a convex saddle adapted to stabilize a log gripped in the jaws.

26. The grapple saw of claim 8 wherein the saw box includes a concave edge adapted to bear against a log in the cutting position.

27. A method of cutting a log from a felled tree comprising the steps of:
(a) pivoting downwardly disposed jaws of a grapple in a direction generally perpendicular to a felled tree for grasping the felled tree;
(b) holding the felled tree in generally parallel relation to the ground;
(c) pivoting a saw blade attached to at least one of the jaws of the grapple from a pivot point in a direction generally perpendicular to the felled tree; and
(d) cutting a log from the felled tree by a cut generally perpendicular to a longitudinal orientation of the felled tree, whereby twisting motion of the log during and after the cut is minimized.

28. The method of claim 27 wherein the saw blade terminates the cut at a bottommost portion of the log.
